(19) United States
(12) Patent Application Publication
(10) Pub. No.: US 2010/0143686 A1
(43) Pub. Date: Jun. 10, 2010

(54) Nanomaterial-Filled Silicone Composition and Reinforced Silicone Resin Film

(76) Inventor: Bizhong Zhu, Midland, MI (US)

Correspondence Address: DOW CORNING CORPORATION CO1232, 2200 W. SALZBURG ROAD, P.O. BOX 994, MIDLAND, MI, 48686-0994, US

(21) Appl. No.: 12/596,730

(22) PCT Filed: Apr. 16, 2008
(86) PCT No.: PCT/US08/60422

§ 371 Date: Oct. 20, 2009

Related U.S. Application Data
(60) Provisional application No. 60/915,129, filed on May 1, 2007.

(51) Int. Cl. B32B 27/00; C08L 83/04

(52) U.S. Cl. 428/220; 524/588; 977/773

(57) ABSTRACT

A nanomaterial-filled silicone composition comprising a silicone resin comprising disilyloxane units, a carbon nano-material, and an organic solvent; and a reinforced silicone resin film comprising a cured product of the silicone resin, and a carbon nanomaterial dispersed in the cured product.

### CROSS-REFERENCE TO RELATED APPLICATIONS

This application claims the benefit of U.S. Provisional Patent Application Ser. No. 60/915,129, filed on May 1, 2007, under 35 U.S.C. §119(e). U.S. Provisional Patent Application Ser. No. 60/915,129 is hereby incorporated by reference

### FIELD OF THE INVENTION

The present invention relates to a nanomaterial-filled silicone composition and more particularly to a silicone composition comprising a silicone resin comprising disilyloxane units, a carbon nanomaterial, and an organic solvent. The present invention also relates to a reinforced silicone resin film comprising a cured product of the aforementioned silicone resin, and a carbon nanomaterial dispersed in the cured product.

### BACKGROUND OF THE INVENTION

Silicone resins are useful in a variety of applications by virtue of their unique combination of properties, including high thermal stability, good moisture resistance, excellent flexibility, high oxygen resistance, low dielectric constant, and high transparency. For example, silicone resins are widely used as protective or dielectric coatings in the automotive, electronic, construction, appliance, and aerospace industries.

Although silicone resin coatings can be used to protect, insulate, or bond a variety of substrates, free standing silicone resin films have limited utility due to low tear strength, high brittleness, low glass transition temperature, and high coefficient of thermal expansion. Consequently, there is a need for free standing silicone resin films having improved mechanical and thermal properties.

### SUMMARY OF THE INVENTION

The present invention is directed to a nanomaterial-filled silicone composition, comprising:

(A) a silicone resin comprising disilyloxane units having the formula O_{(3-a)/2}R¹ₐSi—SiR¹_{b}O_{(3-b)/2} (I), wherein each R¹ is independently —H, hydrocarbyl, or substituted hydrocarbyl, a is 0, 1, or 2, and b is 0, 1, 2 or 3;

(B) a carbon nanomaterial; and

(C) an organic solvent.

The present invention is also directed to a reinforced silicone resin film, comprising:

a cured product of at least one silicone resin comprising disilyloxane units having the formula O_{(3-a)/2}R¹ₐSi—SiR¹_{b}O_{(3-b)/2} (I), wherein each R¹ is independently —H, hydrocarbyl, or substituted hydrocarbyl, a is 0, 1, or 2, and b is 0, 1, 2 or 3; and

a carbon nanomaterial dispersed in the cured product.

The reinforced silicone resin film of the present invention has low coefficient of thermal expansion, high tensile strength, and high modulus compared to an un-reinforced silicone resin film prepared from the same silicone composition. Also, although the reinforced and un-reinforced silicone resin films have comparable glass transition temperatures, the reinforced film exhibits a much smaller change in modulus in the temperature range corresponding to the glass transition.

The reinforced silicone resin film of the present invention is useful in applications requiring films having high thermal stability, flexibility, mechanical strength, and transparency. For example, the silicone resin film can be used as an integral component of flexible displays, solar cells, flexible electronic boards, touch screens, fire-resistant wallpaper, and impact-resistant windows. The film is also a suitable substrate for transparent or nontransparent electrodes.

### DETAILED DESCRIPTION OF THE INVENTION

As used herein, the term “disilyloxane units” refers to organosilicon units having the formula O_{(3-a)/2}R¹ₐSi—SiR¹_{b}O_{(3-b)/2} (I), where R¹, a, and b are defined below. Also, the term “mol % of disilyloxane units having the formula (I)” is defined as the ratio of the number of moles of disilyloxane units having the formula (I) in the silicone resin to the sum of the number of moles of siloxane units and disilyloxane units in the resin, multiplied by 100. Further, the term “mol % of siloxane units having the form of particles” is defined as the ratio of the number of moles of siloxane units having the form of particles in the resin to the sum of the number of moles of siloxane units and disilyloxane units in the resin, multiplied by 100.

A nanomaterial-filled silicone composition according to the present invention, comprises:

(A) a silicone resin comprising disilyloxane units having the formula O_{(3-a)/2}R¹ₐSi—SiR¹_{b}O_{(3-b)/2} (I), wherein each R¹ is independently —H, hydrocarbyl, or substituted hydrocarbyl, a is 0, 1, or 2, and b is 0, 1, 2 or 3;

(B) a carbon nanomaterial; and

(C) an organic solvent.

Component (A) is at least one silicone resin comprising disilyloxane units having the formula O_{(3-a)/2}R¹ₐSi—SiR¹_{b}O_{(3-b)/2} (I), wherein each R¹ is independently —H, hydrocarbyl, or substituted hydrocarbyl; a is 0, 1, or 2; and b is 0, 1, 2 or 3.

The hydrocarbyl groups represented by R¹ typically have from 1 to 10 carbon atoms, alternatively from 1 to 6 carbon atoms, alternatively from 1 to 4 carbon atoms. Acyclic hydrocarbyl groups containing at least three carbon atoms can have a branched or unbranched structure. Examples of hydrocarbyl groups include, but are not limited to, alkyl, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, octyl, nonyl, and decyl; cycloalkyl, such as cyclopentyl, cyclohexyl, and methylcyclohexyl; aryl, such as phenyl and napthyl; alkaryl, such as tolyl and xylyl; arakyl, such as benzyl and phenethyl; alkenyl, such as vinyl, allyl, and propenyl; aralkenyl, such as styryl and cinnamyl; and alkynyl, such as ethynyl and propynyl.

The substituted hydrocarbyl groups represented by R¹ can contain one or more of the same or different substituents, provided the substituent does not prevent formation of the alcoholysis product, the hydrolyzate, or the silicone resin. Examples of substituents include, but are not limited to, —F, —Cl, —Br, —I, —OH, —OR², —OCH₂CH₂OR³, —CO₂R³, —OC(═O)R², —C(═O)NR³₂, wherein R² is C₁ to C₈ hydrocarbyl and R³ is R² or —H.

The hydrocarbyl groups represented by R² typically have from 1 to 8 carbon atoms, alternatively from 3 to 6 carbon atoms. Acyclic hydrocarbyl groups containing at least 3 carbon atoms can have a branched or unbranched structure. Examples of hydrocarbyl include, but are not limited to, unbranched and branched alkyl, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, and octyl; cycloalkyl, such as cyclopentyl, cyclohexyl, and methylcyclohexyl; phenyl; alkaryl, such as tolyl and xylyl; aralkyl, such as benzyl and phenethyl; alkenyl, such as vinyl, allyl, and propenyl; arylalkenyl, such as styryl; and alkynyl, such as ethynyl and propynyl.

The silicone resin typically comprises at least 1 mol % of disilyloxane units having the formula (I). For example, the silicone resin typically comprises from 1 to 100 mol %, alternatively from 5 to 75 mol %, alternatively from 10 to 50 mol %, of disilyloxane units having the formula (I).

In addition to disilyloxane units having the formula (I), the silicone resin may contain up to 99 mol % of other siloxane units. Examples of other siloxane units include, but are not limited to, siloxane units having formulae selected from: R¹₃SiO_{1/2}, R¹₂SiO_{2/2}, R¹SiO_{3/2}, and SiO_{4/2}, wherein R¹ is as described and exemplified above.

The silicone resin typically has a number-average molecular weight of from 200 to 500,000, alternatively from 500 to 150,000, alternatively from 1,000 to 75,000, alternatively from 2,000 to 12,000, wherein the molecular weight is determined by gel permeation chromatography using a refractive index detector and polystyrene standards.

The silicone resin typically contains from 1 to 50% (w/w), alternatively from 5 to 50% (w/w), alternatively from 5 to 35% (w/w), alternatively from 10% to 35% (w/w), alternatively from 10 to 20% (w/w), of silicon-bonded hydroxy groups based on the total weight of the resin, as determined by ²⁹Si NMR.

According to a first embodiment, the silicone resin has the formula:

[O_{(3-a)/2}R¹ₐSi—SiR¹_{b}O_{(3-b)/2}]ᵥ(R¹₃SiO_{1/2})_{w}(R¹₂SiO_{2/2})ₓ(R¹SiO_{3/2})_{y}(SiO_{4/2})_{z} (II),

wherein each R¹ is independently —H, hydrocarbyl, or substituted hydrocarbyl; a is 0, 1, or 2; b is 0, 1, 2 or 3; v is from 0.01 to 1; w is from 0 to 0.84; x is from 0 to 0.99; y is from 0 to 0.99; z is from 0 to 0.95; and v+w+x+y+z=1.

The hydrocarbyl and substituted hydrocarbyl groups represented by R¹ are as described and exemplified above.

In the formula (II) of the silicone resin, the subscripts v, w, x, y, and z are mole fractions. The subscript v typically has a value of from 0.01 to 1, alternatively from 0.2 to 0.8, alternatively from 0.3 to 0.6; the subscript w typically has a value of from 0 to 0.84, alternatively from 0.1 to 0.6, alternatively from 0.2 to 0.4; the subscript x typically has a value of from 0 to 0.99, alternatively from 0.1 to 0.8, alternatively from 0.2 to 0.6; the subscript y typically has a value of from 0 to 0.99, alternatively from 0.2 to 0.8, alternatively from 0.4 to 0.6; and the subscript z typically has a value of from 0 to 0.95, alternatively from 0.1 to 0.7, alternatively from 0.2 to 0.5.

Examples of silicone resins having the formula (II) include, but are not limited to, resins having the following formulae: (O_{2/2}MeSiSiO_{3/2})_{0.1}(PhSiO_{3/2})_{0.9}, (O_{2/2}MeSiSiMeO_{2/2})_{0.2}(Me₂SiO_{2/2})_{0.1}(PhSiO_{3/2})_{0.7}, (O_{2/2}MeSiSiO_{3/2})_{0.1}(O_{2/2}MeSiSiMeO_{2/2})_{0.15}(Me₂SiO_{2/2})_{0.1}(MeSiO_{3/2})_{0.65}, (O_{1/2}Me₂SiSiO_{3/2})_{0.25}(SiO_{4/2})_{0.5}(MePhSiO_{2/2})_{0.25}, (O_{2/2}EtSiSiEt₂O_{1/2})_{0.1}(O_{2/2}MeSiSiO_{3/2})_{0.15}(Me₃SiO_{1/2})_{0.05}(PhSiO_{3/2})_{0.5}(SiO_{4/2})_{0.2}, (O_{2/2}MeSiSiO_{3/2})_{0.3}(PhSiO_{3/2})_{0.7}, (O_{2/2}MeSiSiO_{3/2})_{0.4}(MeSiO_{3/2})_{0.6}, (O_{3/2}SiSiMeO_{2/2})_{0.5}(Me₂SiO_{2/2})_{0.5}, (O_{3/2}SiSiMeO_{2/2})_{0.6}(Me₂SiO_{2/2})_{0.4}, (O_{3/2}SiSiMeO_{2/2})_{0.7}(Me₂SiO_{2/2})_{0.3}, (O_{3/2}SiSiMe₂O_{1/2})_{0.75}(PhSiO_{3/2})_{0.25}, (O_{3/2}SiSiMeO_{2/2})_{0.75}(SiO_{4/2})_{0.25}, (O_{2/2}MeSiSiMe₂O_{1/2})_{0.5}(O_{2/2}MeSiSiO_{3/2})_{0.3}(PhSiO_{3/2})_{0.2}, (O_{2/2}EtSiSiMeO_{2/2})_{0.8}(MeSiO_{3/2})_{0.05}(SiO_{4/2})_{0.15}, (O_{2/2}MeSiSiO_{3/2})_{0.8}(Me₃SiO_{1/2})_{0.05}(Me₂SiO_{2/2})_{0.1}(SiO_{4/2})_{0.5}, (O_{2/2}MeSiSiEtO_{2/2})_{0.25}(O_{3/2}SiSiMeO_{2/2})_{0.6}(MeSiO_{3/2})_{0.1}(SiO_{4/2})_{0.05}, (O_{1/2}Me₂SiSiMeO_{2/2})_{0.75}(O_{2/2}MeSiSiMeO_{2/2})_{0.25}, (O_{1/2}Et₂SiSiEtO_{2/2})_{0.5}(O_{2/2}EtSiSiEtO_{2/2})_{0.5}, (O_{1/2}Et₂SiSiEtO_{2/2})_{0.2}(O_{2/2}MeSiSiMeO_{2/2})_{0.8}, and (O_{1/2}Me₂SiSiMeO_{2/2})_{0.6}(O_{2/2}EtSiSiEtO_{2/2})_{0.4}, where Me is methyl, Et is ethyl, Ph is phenyl, the resin contains siloxane units in the form of particles, and the numerical subscripts outside the parenthesis denote mole fractions. Also, in the preceding formulae, the sequence of units is unspecified.

The silicone resin of the first embodiment can be prepared by (i) reacting at least one halodisilane having the formula Z₃₋ₐR¹ₐSi—SiR¹_{b}Z_{3-b} and, optionally, at least one halosilane having the formula R¹_{b}SiZ_{4-b} with at least one alcohol having the formula R⁴OH in the presence of an organic solvent to produce an alcoholysis product, wherein each R¹ is independently —H, hydrocarbyl, or substituted hydrocarbyl, R⁴ is alkyl or cycloalkyl, Z is halo, a=0, 1, or 2, and b=0, 1, 2 or 3; (ii) reacting the alcoholysis product with water at a temperature of from 0 to 40° C. to produce a hydrolyzate; and (iii) heating the hydrolyzate to produce the resin.

In step (i) of the method of preparing the silicone resin at least one halodisilane having the formula Z₃₋ₐR¹ₐSi—SiR¹_{b}Z_{3-b} and, optionally, at least one halosilane having the formula R¹_{b}SiZ_{4-b} are reacted with at least one alcohol having the formula R⁴OH in the presence of an organic solvent to produce an alcoholysis product, wherein each R¹ is independently —H, hydrocarbyl, or substituted hydrocarbyl, R⁴ is alkyl or cycloalkyl, Z is halo, a=0, 1, or 2, and b=0, 1, 2 or 3. As used herein, the term “alcoholysis product” refers to a product formed by replacement of the silicon-bonded halogen atom(s) in the halodisilane and, when present, the halosilane with the group —OR⁴, wherein R⁴ is as described and exemplified below.

The halodisilane is at least one halodisilane having the formula Z₃₋ₐR¹ₐSi—SiR¹_{b}Z_{3-b}, wherein R¹ is as described and exemplified above, Z is halo, a=0, 1, or 2, and b=0, 1, 2 or 3. Examples of halo atoms represented by Z include —F, —Cl, —Br, and —I.

Examples of halodisilanes include, but are not limited to, disilanes having the formulae: Cl₂MeSiSiMeCl₂, Cl₂MeSiSiMe₂Cl, Cl₃SiSiMeCl₂, Cl₂EtSiSiEtCl₂, Cl₂EtSiSiEt₂Cl, Cl₃SiSiEtCl₂, Cl₃SiSiCl₃, Br₂MeSiSiMeBr₂, Br₂MeSiSiMe₂Br, Br₃SiSiMeBr₂, Br₂EtSiSiEtBr₂, Br₂EtSiSiEt₂Br, Br₃SiSiEtBr₂, Br₃SiSiBr₃, I₂MeSiSiMeI₂, I₂MeSiSiMe₂I, I₃SiSiMeI₂, I₂EtSiSiEtI₂, I₂EtSiSiEt₂I, I₃SiSiEtI₂, and I₃SiSiI₃, where Me is methyl and Et is ethyl.

The halodisilane can be a single halodisilane or a mixture comprising two or more different halodisilanes, each having the formula Z₃₋ₐR¹ₐSi—SiR¹_{b}Z_{3-b}, wherein R¹, Z, a, and b are as described and exemplified above.

Methods of preparing halodisilanes are well known in the art; many of these compounds are commercially available. Also, the halodisilane can be obtained from the residue having a boiling point greater than 70° C. produced in the Direct Process for making methylchlorosilanes, as taught in WO 03/099828. Fractional distillation of the Direct Process residue gives a methylchlorodisilane stream containing a mixture of chlorodisilanes.

The optional halosilane is at least one halosilane having the formula R¹_{b}SiZ_{4-b}, wherein R¹, Z, and b are as described and exemplified above.

Examples of halosilanes include, but are not limited to, silanes having the formulae: SiCl₄, SiBr₄, HSiCl₃, HSiBr₃, MeSiCl₃, EtSiCl₃, MeSiBr₃, EtSiBr₃, Me₂SiCl₂, Et₂SiCl₂, Me₂SiBr₂, Et₂SiBr₂, Me₃SiCl, Et₃SiCl, and Me₃SiBr, Et₃SiBr, where Me is methyl and Et is ethyl.

The halosilane can be a single halosilane or a mixture comprising two or more different halosilanes, each having the formula R¹_{b}SiZ_{4-b}, wherein R¹, Z, and b are as described and exemplified above. Further, methods of preparing halosilanes are well known in the art; many of these compounds are commercially available.

The alcohol is at least one alcohol having the formula R⁴OH, wherein R⁴ is alkyl or cycloalkyl. The structure of the alcohol can be linear or branched. Also, the hydroxy group in the alcohol may be attached to a primary, secondary or tertiary carbon atom.

The alkyl groups represented by R⁴ typically have from 1 to 8 carbon atoms, alternatively from 1 to 6 carbon atoms, alternatively from 1 to 4 carbon atoms. Alkyl groups containing at least 3 carbon atoms can have a branched or unbranched structure. Examples of alkyl groups include, but are not limited to, methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, and octyl.

The cycloalkyl groups represented by R⁴ typically have from 3 to 12 carbon atoms, alternatively from 4 to 10 carbon atoms, alternatively from 5 to 8 carbon atoms. Examples of cycloalkyl groups include, but are not limited to, cyclopentyl, cyclohexyl, and methylcyclohexyl.

Examples of alcohols include, but are not limited to, methanol, ethanol, 1-propanol, 2-propanol, 1-butanol, 2-butanol, 2-methyl-1-butanol, 1,1-dimethyl-1-ethanol, pentanol, hexanol, cyclohexanol, heptanol, and octanol. The alcohol can be a single alcohol or a mixture comprising two or more different alcohols, each as described and exemplified above.

The organic solvent can be any aprotic or dipolar aprotic organic solvent that does not react with the halodisilane, the halosilane, or the silicone resin product under the conditions of the present method, and is miscible with the halodisilane, the halosilane, and the silicone resin. The organic solvent can be immiscible or miscible with water. As used herein, the term “immiscible” means that the solubility of water in the solvent is less than about 0.1 g/100 g of solvent at 25° C. The organic solvent can also be the alcohol having the formula R⁴OH, wherein R⁴ is as described and exemplified above, that is reacted with the halodisilane and, optionally, the halosilane.

Examples of organic solvents include, but are not limited to, saturated aliphatic hydrocarbons such as n-pentane, hexane, n-heptane, isooctane and dodecane; cycloaliphatic hydrocarbons such as cyclopentane and cyclohexane; aromatic hydrocarbons such as benzene, toluene, xylene and mesitylene; cyclic ethers such as tetrahydrofuran (THF) and dioxane; ketones such as methyl isobutyl ketone (MIBK); halogenated alkanes such as trichloroethane; halogenated aromatic hydrocarbons such as bromobenzene and chlorobenzene; and alcohols such as methanol, ethanol, 1-propanol, 2-propanol, 1-butanol, 2-butanol, 2-methyl-1-butanol, 1,1-dimethyl-1-ethanol, pentanol, hexanol, cyclohexanol, hepatanol, and octanol.

The organic solvent can be a single organic solvent or a mixture comprising two or more different organic solvents, each as described and exemplified above.

The reaction of the halodisilane and the optional halosilane with the alcohol to produce the alcoholysis product can be carried out in any standard reactor suitable for contacting, for example, halosilanes with alcohol. Suitable reactors include glass and Teflon-lined glass reactors. Preferably, the reactor is equipped with a means of agitation, such as stirring.

The halodisilane, the optional halosilane, the alcohol, and the organic solvent can be combined in any order. Typically, the halodisilane and optional halosilane are combined with the alcohol in the presence of the organic solvent by adding the alcohol to a mixture of the halodisilane, optional halosilane, and organic solvent. Reverse addition, i.e., addition of the silane(s) to the alcohol is also possible. The hydrogen halide gas (e.g., HCl) produced as a by-product in the reaction is typically allowed to pass from the reaction vessel into an acid neutralization trap.

The rate of addition of the alcohol to the halodisilane and the optional halosilane is typically from 5 mL/min. to 50 mL/min. for a 1000-mL reaction vessel equipped with an efficient means of stirring. When the rate of addition is too slow, the reaction time is unnecessarily prolonged. When the rate of addition is too fast, the violent evolution of hydrogen halide gas may be hazardous.

The reaction of the halodisilane and the optional halosilane with the alcohol is typically carried out at room temperature (˜23±2° C.). However, the reaction can be carried out at lower or higher temperatures. For example, the reaction can be carried out at a temperature of from 10° C. to 60° C.

The reaction time depends on several factors, including the structures of the halodisilane and the optional halosilane, and the temperature. The reaction is typically carried out for an amount of time sufficient to complete alcoholysis of the halodisilane and the optional halosilane. As used herein, the term “to complete alcoholysis” means that at least 85 mol % of the silicon-bonded halogen atoms originally present in the halodisilane and the optional halosilane combined are replaced with the group —OR⁴. For example, the reaction time is typically from 5 to 180 min., alternatively from 10 to 60 min., alternatively from 15 to 25 min., at a temperature of from 10 to 60° C. The optimum reaction time can be determined by routine experimentation using the methods set forth in the Examples section below.

The concentration of the halodisilane in the reaction mixture is typically from 5 to 95% (w/w), alternatively from 20 to 70% (w/w), alternatively from 40 to 60% (w/w), based on the total weight of the reaction mixture.

The mole ratio of the halosilane to the halodisilane is typically from 0 to 99, alternatively from 0.5 to 80, alternatively from 0.5 to 60, alternatively from 0.5 to 40, alternatively from 0.5 to 20, alternatively from 0.5 to 2.

The mole ratio of the alcohol to the silicon-bonded halogen atoms in the halodisilane and the halosilane combined is typically from 0.5 to 10, alternatively from 1 to 5, alternatively from 1 to 2.

The concentration of the organic solvent is typically from 0 to 95% (w/w), alternatively from 5 to 88% (w/w), alternatively from 30 to 82% (w/w), based on the total weight of the reaction mixture.

In step (ii) of the method, the alcoholysis product is reacted with water at a temperature of from 0 to 40° C. to produce a hydrolyzate.

The alcoholysis product is typically combined with water by adding the alcoholysis product to the water. Reverse addition, i.e., addition of water to the alcoholysis product is also possible. However, reverse addition may result in formation of predominantly gels.

The rate of addition of the alcoholysis product to water is typically from 2 mL/min. to 100 mL/min. for a 1000-mL reaction vessel equipped with an efficient means of stirring. When the rate of addition is too slow, the reaction time is unnecessarily prolonged. When the rate of addition is too fast, the reaction mixture may form a gel.

The reaction of step (ii) is typically carried out at a temperature of from 0 to 40° C., alternatively from 0 to 20° C., alternatively from 0 to 5° C. When the temperature is less than 0° C., the rate of the reaction is typically very slow. When the temperature is greater than 40° C., the reaction mixture may form a gel.

The reaction time depends on several factors, including the structure of the alcoholysis product and the temperature. The reaction is typically carried out for an amount of time sufficient to complete hydrolysis of the alcoholysis product. As used herein, the term “to complete hydrolysis” means that at least 85 mol % of the silicon-bonded groups —OR⁴ originally present in the alcoholysis product are replaced with hydroxy groups. For example, the reaction time is typically from 0.5 min. to 5 h, alternatively from 1 min. to 3 h, alternatively from 5 min. to 1 h at a temperature of from 0 to 40° C. The optimum reaction time can be determined by routine experimentation using the methods set forth in the Examples section below.

The concentration of water in the reaction mixture is typically sufficient to effect hydrolysis of the alcoholysis product. For example, the concentration of water is typically from 1 mole to 50 moles, alternatively from 5 moles to 20 moles, alternatively from 8 moles to 15 moles, per mole of the silicon-bonded groups —OR⁴ in the alcoholysis product.

In step (iii) of the method of preparing the silicone resin, the hydrolyzate is heated to produce the silicone resin. The hydrolyzate is typically heated at a temperature of from 40 to 100° C., alternatively from 50 to 85° C., alternatively from 55 to 70° C. The hydrolyzate is typically heated for a period of time sufficient to produce a silicone resin having a number-average molecular weight of from 200 to 500,000. For example, the hydrolyzate is typically heated for a period of from 1 h to 2 h, at a temperature of from 55° C. to 70° C.

The method can further comprise recovering the silicone resin. When the mixture of step (iii) contains a water-immiscible organic solvent, such as tetrahydrofuran, the silicone resin can be recovered from the reaction mixture by separating the organic phase containing the resin from the aqueous phase. The separation can be carried out by discontinuing agitation of the mixture, allowing the mixture to separate into two layers, and removing the aqueous or organic phase. The organic phase is typically washed with water. The water can further comprise a neutral inorganic salt, such as sodium chloride, to minimize formation of an emulsion between the water and organic phase during washing. The concentration of the neutral inorganic salt in the water can be up to saturation. The organic phase can be washed by mixing it with water, allowing the mixture to separate into two layers, and removing the aqueous layer. The organic phase is typically washed from 1 to 5 times with separate portions of water. The volume of water per wash is typically from 0.5 to 2 times the volume of the organic phase. The mixing can be carried out by conventional methods, such as stirring or shaking. The silicone resin can be used without further isolation or purification or the resin can be separated from most of the solvent by conventional methods of evaporation.

When the mixture of step (iii) contains a water-miscible organic solvent (e.g., methanol), the silicone resin can be recovered from the reaction mixture by separating the resin from the aqueous solution. For example, the separation can be carried out by distilling the mixture at atmospheric or subatmospheric pressure. The distillation is typically carried out at a temperature of from 40 to 60° C., alternatively from 60 to 80° C., at a pressure of 0.5 kPa.

Alternatively, the silicone resin can be separated from the aqueous solution by extracting the mixture containing the resin with a water immiscible organic solvent, such as methyl isobutyl ketone. The silicone resin can be used without further isolation or purification or the resin can be separated from most of the solvent by conventional methods of evaporation.

According to a second embodiment, the silicone resin comprises disilyloxane units having the formula O_{(3-a)/2}R¹ₐSi—SiR¹_{b}O_{(3-b)/2} (I), and siloxane units having the form of particles, wherein each R¹ is independently —H, hydrocarbyl, or substituted hydrocarbyl; a is 0, 1, or 2; and b is 0, 1, 2 or 3. The hydrocarbyl and substituted hydrocarbyl groups represented by R¹ are as described and exemplified above.

The silicone resin of the second embodiment comprises both disilyloxane units having the formula (I) and siloxane units having the form of particles. The silicone resin typically comprises at least 1 mol % of disilyloxane units having the formula (I). For example, the silicone resin typically comprises from 1 to 99 mol %, alternatively from 10 to 70 mol %, alternatively from 20 to 50 mol %, of disilyloxane units having the formula (I).

In addition to disilyloxane units having the formula (I), the silicone resin of the second embodiment typically comprises up to 99 mol % of siloxane units having the form of particles. For example, the silicone resin typically contains from 0.0001 to 99 mol %, alternatively from 1 to 80 mol %, alternatively from 10 to 50 mol %, of siloxane units having the form of particles. The composition and properties of the particles are described below in the method of preparing the silicone resin.

In addition to units having formulae (I) and siloxane units having the form of particles, the silicone resin of the second embodiment may contain up to 98.9 mol %, alternatively up to 90 mol %, alternatively up to 60 mol %, of other siloxane units (i.e., siloxane units not having the form of particles). Examples of other siloxane units include, but are not limited to, units having formulae selected from: R¹₃SiO_{1/2}, R¹₂SiO_{2/2}, RiSiO_{3/2}, and SiO_{4/2}, wherein R¹ is as described and exemplified above.

Examples of silicone resins according to the second embodiment include, but are not limited to, resins having the following formulae: (O_{2/2}MeSiSiO_{3/2})_{0.1}(PhSiO_{3/2})_{0.9}, (O_{2/2}MeSiSiMeO_{2/2})_{0.2}(Me₂SiO_{2/2})_{0.1}(PhSiO_{3/2})_{0.7}, (O_{2/2}MeSiSiO_{3/2})_{0.1}(O_{2/2}MeSiSiMeO_{2/2})_{0.15}(Me₂SiO_{2/2})_{0.1}(MeSiO_{3/2})_{0.65}, (O_{1/2}Me₂SiSiO_{3/2})_{0.25}(SiO_{4/2})_{0.5}(MePhSiO_{2/2})_{0.25}, (O_{2/2}EtSiSiEt₂O_{1/2})_{0.1}(O_{2/2}MeSiSiO_{3/2})_{0.15}(Me₃SiO_{1/2})_{0.05}(PhSiO_{3/2})_{0.5}(SiO_{4/2})_{0.2}, (O_{2/2}MeSiSiO_{3/2})_{0.3}(PhSiO_{3/2})_{0.7}, (O_{2/2}MeSiSiO_{3/2})_{0.4}(MeSiO_{3/2})_{0.6}, (O_{3/2}SiSiMeO_{2/2})_{0.5}(Me₂SiO_{2/2})_{0.5}, (O_{3/2}SiSiMeO_{2/2})_{0.6}(Me₂SiO_{2/2})_{0.4}, (O_{3/2}SiSiMeO_{2/2})_{0.7}(Me₂SiO_{2/2})_{0.3}, (O_{3/2}SiSiMe₂O_{1/2})_{0.75}(PhSiO_{3/2})_{0.25}, (O_{3/2}SiSiMeO_{2/2})_{0.75}(SiO_{4/2})_{0.25}, (O_{2/2}MeSiSiMe₂O_{1/2})_{0.5}(O_{2/2}MeSiSiO_{3/2})_{0.3}(PhSiO_{3/2})_{0.2}, (O_{2/2}EtSiSiMeO_{2/2})_{0.8}(MeSiO_{3/2})_{0.05}(SiO_{4/2})_{0.15}, (O_{2/2}MeSiSiO_{3/2})_{0.8}(Me₃SiO_{1/2})_{0.05}(Me₂SiO_{2/2})_{0.1}(SiO_{4/2})_{0.5}, (O_{2/2}MeSiSiEtO_{2/2})_{0.25}(O_{3/2}SiSiMeO_{2/2})_{0.6}(MeSiO_{3/2})_{0.1}(SiO_{4/2})_{0.05}, (O_{1/2}Me₂SiSiMeO_{2/2})_{0.75}(O_{2/2}MeSiSiMeO_{2/2})_{0.25}, (O_{1/2}Et₂SiSiEtO_{2/2})_{0.5}(O_{2/2}EtSiSiEtO_{2/2})_{0.5}, (O_{1/2}Et₂SiSiEtO_{2/2})_{0.2}(O_{2/2}MeSiSiMeO_{2/2})_{0.8}, and (O_{1/2}Me₂SiSiMeO_{2/2})_{0.6}(O_{2/2}EtSiSiEtO_{2/2})_{0.4}, where Me is methyl, Et is ethyl, Ph is phenyl, the resin contains siloxane units in the form of particles, and the numerical subscripts outside the parenthesis denote mole fractions. Also, in the preceding formulae, the sequence of units is unspecified.

The silicone resin of the second embodiment can be prepared by (i) reacting at least one halodisilane having the formula Z₃₋ₐR¹ₐSi—SiR¹_{b}Z_{3-b} and, optionally, at least one halosilane having the formula R¹_{b}SiZ_{4-b} with at least one alcohol having the formula R⁴OH in the presence of an organic solvent to produce an alcoholysis product, wherein each R¹ is independently —H, hydrocarbyl, or substituted hydrocarbyl, R⁴ is alkyl or cycloalkyl, Z is halo, a=0, 1, or 2, and b=0, 1, 2 or 3; (ii) reacting the alcoholysis product with water in the presence of siloxane particles at a temperature of from 0 to 40° C. to produce a hydrolyzate; and (iii) heating the hydrolyzate to produce the resin.

Step (i) of the method of preparing the silicone resin of the second embodiment is as described above for step (i) of the method of preparing the silicone resin of the first embodiment.

In step (ii) of the method of preparing the silicone resin of the second embodiment, the alcoholysis product is reacted with water in the presence of siloxane particles at a temperature of from 0 to 40° C. to produce a hydrolyzate.

The siloxane particles of the present method can be any particles comprising siloxane units. The siloxane units may be represented by the following formulae: R¹₂SiO_{1/2} units (M units), R¹₂SiO_{2/2} units (D units), R¹SiO_{3/2} units (T units), and SiO_{4/2} units (Q units), where R¹ is as described and exemplified above.

The siloxane particles typically have a median particle size (based on mass) of from 0.001 to 500 μm, alternatively from 0.01 to 100 μm.

Although the shape of the siloxane particles is not critical, particles having a spherical shape are preferred because they generally impart a smaller increase in viscosity to the silicone composition than particles having other shapes.

Examples of siloxane particles include, but are not limited to, silica particles comprising SiO_{4/2} units, such as colloidial silica, dispersed pyrogenic (fumed) silica, precipitated silica, and coacervated silica; silicone resin particles comprising R¹SiO_{3/2} units, such as particles comprising MeSiO_{3/2} units, particles comprising MeSiO_{3/2} units and PhSiO_{3/2} units, and particles comprising MeSiO_{3/2} units and Me₂SiO_{2/2} units; and silicone elastomer particles comprising R¹₂SiO_{2/2} units, such as particles comprising a cross-linked product of a poly(dimethylsiloxane/methylvinylsiloxane) and a poly(hydrogenmethylsiloxane/dimethylsiloxane); wherein R¹ is a described and exemplified above.

The siloxane particles can also be a metal polysilicate having the formula (M^{+a}O_{a/2})ₓ(SiO_{4/2})_{y}, where M is a metal cation having the charge +a, where a is an integer from 1 to 7, x has a value of from greater than zero to 0.01, y has a value of from 0.99 to less than 1, and the sum x+y=1. Examples of metals include, but are not limited to, alkali metals such as sodium and potassium; alkaline earth metals such as beryllium, magnesium, and calcium; transition metals such as iron, zinc, chromium, and zirconium; and aluminum. Examples of metal polysilicates include a polysilicate having the formula (Na₂O)_{0.01}(SiO₂)_{0.99}.

The siloxane particles can also be treated siloxane particles prepared by treating the surfaces of the aforementioned particles with an organosilicon compound. The organosilicon compound can be any of the organosilicon compounds typically used to treat silica fillers. Examples of organosilicon compounds include, but are not limited to, organochlorosilanes such as methyltrichlorosilane, dimethyldichlorosilane, and trimethyl monochlorosilane; organosiloxanes such as hydroxy-endblocked dimethylsiloxane oligomer, hexamethyldisiloxane, and tetramethyldivinyldisiloxane; organosilazanes such as hexamethyldisilazane, hexamethylcyclotrisilazane; and organoatkoxysilanes such as methyltrimethoxysilane, vinyltrimethoxysilane, vinyltriethoxysilane, 3-glycidoxypropyltrimethoxysilane, and 3-methacryloxypropyltrimethoxysilane.

The siloxane particles of the present method can comprise a single type of siloxane particles or two or more different types of siloxane particles that differ in at least one of the following properties: composition, surface area, surface treatment, particle size, and particle shape.

Methods of preparing silicone resin particles and silicone elastomer particles are well known in the art. For example, silicone resin particles can be prepared by the hydrolysis-condensation of alkoxysilane(s) in an aqueous alkaline medium, as exemplified in U.S. Pat. No. 5,801,262 and U.S. Pat. No. 6,376,078. Silicone elastomer particles can be prepared by spray drying and curing a curable organopolysiloxane composition, as described in Japanese Patent Application No. 59096122; spray-drying an aqueous emulsion of a curable organopolysiloxane composition, as disclosed in U.S. Pat. No. 4,761,454; curing an emulsion of a liquid silicone rubber microsuspension, as disclosed in U.S. Pat. No. 5,371,139; or pulverizing cross-linked silicone rubber elastomer.

The alcoholysis product is typically combined with water by adding the alcoholysis product to a mixture of the water and siloxane particles. Reverse addition, i.e., addition of water to the alcoholysis product is also possible. However, reverse addition may result in formation of predominantly gels.

The rate of addition of the alcoholysis product to the mixture of water and siloxane particles is typically from 2 mL/min. to 100 mL/min. for a 1000-mL reaction vessel equipped with an efficient means of stirring. When the rate of addition is too slow, the reaction time is unnecessarily prolonged. When the rate of addition is too fast, the reaction mixture may form a gel.

The reaction temperature, reaction time, and concentration of water in the reaction mixture are as described above for step (ii) of the method of preparing the silicone resin of the first embodiment.

The concentration of the siloxane particles in the reaction mixture is typically from 0.0001 to 99% (w/w), alternatively from 1 to 80% (w/w), alternatively from 10 to 50% (w/w), based on the total weight of the reaction mixture.

Step (iii) of the method of preparing the silicone resin of the second embodiment is as described above for step (iii) of the method of preparing the silicone resin of the first embodiment. Furthermore, the silicone resin of the second embodiment can be recovered from the reaction mixture as described above for the silicone resin of the first embodiment.

Component (A) of the nanomaterial-filled silicone composition can comprise a single silicone resin or a mixture comprising two or more different silicone resins, each as described above.

The concentration of component (A) is typically from 0.01 to 99.99% (w/w), alternatively from 20 to 99% (w/w), alternatively from 30 to 95% (w/w), alternatively from 50 to 80% (w/w), based on the total weight of the nanomaterial-filled silicone composition.

Component (B) of the nanomaterial-filled silicone composition is at least one carbon nanomaterial. The carbon nanomaterial can be any carbon material having at least one physical dimension (e.g., particle diameter, fiber diameter, layer thickness) less than about 200 nm. Examples of carbon nanomaterials include, but are not limited to, carbon nanoparticles having three dimensions less than about 200 nm, such as quantum dots, hollow spheres, and fullerenes; fibrous carbon nanomaterials having two dimensions less than about 200 nm, such as nanotubes (e.g., single-walled nanotubes and multi-walled nanotubes) and nanofibers (e.g., axially aligned, platelet, and herringbone or fishbone nanofibers); and layered carbon nanomaterials having one dimension less than about 200 nm, such as carbon nanoplatelets (e.g., exfoliated graphite and graphene sheet). The carbon nanomaterial can be electrically conductive or semiconductive.

The carbon nanomaterial can also be an oxidized carbon nanomaterial, prepared by treating the aforementioned carbon nanomaterials with an oxidizing acid or mixture of acids at elevated temperature. For example, the carbon nanomaterial can be oxidized by heating the material in a mixture of concentrated nitric and concentrated sulfuric acid (1:3 v/v, 25 mL/g carbon) at a temperature of from 40 to 150° C. for 1-3 hours.

Component (B) can comprise a single carbon nanomaterial or a mixture comprising at least two different carbon nanomaterials, each as described above.

The concentration of component (B) is typically from 0.0001 to 99% (w/w), alternatively from 0.001 to 50% (w/w), alternatively from 0.01 to 25% (w/w), alternatively from 0.1 to 10% (w/w), alternatively from 1 to 5% (w/w), based on the total weight of the nanomaterial-filled silicone composition.

Methods of preparing carbon nanomaterials are well-known in the art. For example, carbon nanoparticles (e.g., fullerenes) and fibrous carbon nanomaterials (e.g., nanotubes, and nanofibers) can be prepared using at least one of the following methods: arc discharge, laser ablation, and catalytic chemical vapor deposition. In the arc discharge process, an arc discharge between two graphite rods produces, depending on the gas atmosphere, single-walled nanotubes, multi-walled nanotubes, and fullerenes. In the laser ablation method, a graphite target loaded with a metal catalyst is irradiated with a laser in a tube furnace to produce single- and multi-walled nanotubes. In the catalytic chemical vapor deposition method, a carbon-containing gas or gas mixture is introduced into a tube furnace containing a metal catalyst at a temperature of from 500 to 1000° C. (and different pressures) to produce carbon nanotubes and nanofibers. Carbon nanoplatelets can be prepared by the intercalation and exfoliation of graphite.

Component (C) of the silicone composition is at least one organic solvent. The organic solvent can be any protic, aprotic, or dipolar aprotic organic solvent that does not react with the silicone resin or any optional ingredients (e.g., a crosslinking agent) and is miscible with the silicone resin.

Examples of organic solvents include, but are not limited to, alcohols, such as methanol, ethanol, 1-propanol, 2-propanol, 1-butanol, 2-butanol, 2-methyl-1-butanol, 1-pentanol, and cyclohexanol; saturated aliphatic hydrocarbons such as n-pentane, hexane, n-heptane, isooctane and dodecane; cycloaliphatic hydrocarbons such as cyclopentane and cyclohexane; aromatic hydrocarbons such as benzene, toluene, xylene and mesitylene; cyclic ethers such as tetrahydrofuran (THF) and dioxane; ketones such as methyl isobutyl ketone (MIBK); halogenated alkanes such as trichloroethane; and halogenated aromatic hydrocarbons such as bromobenzene and chlorobenzene. Component (C) can be a single organic solvent or a mixture comprising two or more different organic solvents, each as defined above.

The concentration of component (C) is typically from 0.01% to 99.5% by weight, alternatively from 40 to 95% by weight, alternatively from 60% to 90% by weight, based on the total weight of the nanomaterial-filled silicone composition.

The nanomaterial-filled silicone composition can comprise additional ingredients, provided the ingredient does not prevent the silicone resin from forming a cured silicone resin, as described below. Examples of additional ingredients include, but are not limited to, adhesion promoters; dyes; pigments; anti-oxidants; heat stabilizers; UV stabilizers, flame retardants, flow control additives, cross-linking agents, and condensation catalysts.

The nanomaterial-filled silicone composition can further comprises a cross-linking agent and/or a condensation catalyst. The cross-linking agent can have the formula R³_{q}SiX_{4-q}, wherein R³ is C₁ to C₈ hydrocarbyl, X is a hydrolysable group, and q is 0 or 1. The hydrocarbyl groups represented by R³ are as described and exemplified above.

As used herein the term “hydrolysable group” means the silicon-bonded group reacts with water in the absence of a catalyst at any temperature from room temperature (˜23±2° C.) to 100° C. within several minutes, for example thirty minutes, to form a silanol (Si—OH) group. Examples of hydrolysable groups represented by X include, but are not limited to, —Cl, —Br, —OR³, —OCH₂CH₂OR⁴, CH₃C(═O)O—, Et(Me)C═N—O—, CH₃C(═O)N(CH₃)—, and —ONH₂, wherein R³ and R⁴ are as described and exemplified above.

Examples of cross-linking agents include, but are not limited to, alkoxy silanes such as MeSi(OCH₃)₃, CH₃Si(OCH₂CH₃)₃, CH₃Si(OCH₂CH₂CH₃)₃, CH₃Si[O(CH₂)₃CH₃]₃, CH₃CH₂Si(OCH₂CH₃)₃, C₆H₅Si(OCH₃)₃, C₆H₅CH₂Si(OCH₃)₃, C₆H₅Si(OCH₂CH₃)₃, CH₂═CHSi(OCH₃)₃, CH₂═CHCH₂Si(OCH₃)₃, CF₃CH₂CH₂Si(OCH₃)₃, CH₃Si(OCH₂CH₂OCH₃)₃, CF₃CH₂CH₂Si(OCH₂CH₂OCH₃)₃, CH₂═CHSi(OCH₂CH₂OCH₃)₃, CH₂═CHCH₂Si(OCH₂CH₂OCH₃)₃, C₆H₅Si(OCH₂CH₂OCH₃)₃, Si(OCH₃)₄, Si(OC₂H₅)₄, and Si(OC₃H₇)₄; organoacetoxysilanes such as CH₃Si(OCOCH₃)₃, CH₃CH₂Si(OCOCH₃)₃, and CH₂═CHSi(OCOCH₃)₃; organoiminooxysilanes such as CH₃Si[O—N═C(CH₃)CH₂CH₃]₃, Si[O—N═C(CH₃)CH₂CH₃]₄, and CH₂═CHSi[O—N═C(CH₃)CH₂CH₃]₃; organoacetamidosilanes such as CH₃Si[NHC(═O)CH₃]₃ and C₆H₅Si[NHC(═O)CH₃]₃; amino silanes such as CH₃Si[NH(s-C₄H₉)]₃ and CH₃Si(NHC₆H₁₁)₃; and organoaminooxysilanes.

The cross-linking agent can be a single silane or a mixture of two or more different silanes, each as described above. Also, methods of preparing tri- and tetra-functional silanes are well known in the art; many of these silanes are commercially available.

When present, the concentration of the cross-linking agent in the nanomaterial-filled silicone composition is sufficient to cure (cross-link) the silicone resin. The exact amount of the cross-linking agent depends on the desired extent of cure, which generally increases as the ratio of the number of moles of silicon-bonded hydrolysable groups in the cross-linking agent to the number of moles of silicon-bonded hydroxy groups in the silicone resin increases. Typically, the concentration of the cross-linking agent is sufficient to provide from 0.2 to 4 moles of silicon-bonded hydrolysable groups per mole of silicon-bonded hydroxy groups in the silicone resin. The optimum amount of the cross-linking agent can be readily determined by routine experimentation.

As stated above, the nanomaterial-filled silicone composition can further comprise at least one condensation catalyst. The condensation catalyst can be any condensation catalyst typically used to promote condensation of silicon-bonded hydroxy (silanol) groups to form Si—O—Si linkages. Examples of condensation catalysts include, but are not limited to, amines; and complexes of lead, tin, zinc, and iron with carboxylic acids. In particular, the condensation catalyst can be selected from tin(II) and tin(IV) compounds such as tin dilaurate, tin dioctoate, and tetrabutyl tin; and titanium compounds such as titanium tetrabutoxide.

The concentration of the condensation catalyst is typically from 0.1 to 10% (w/w), alternatively from 0.5 to 5% (w/w), alternatively from 1 to 3% (w/w), based on the total weight of the nanomaterial-filled silicone resin.

When the nanomaterial-filled silicone composition described above contains a condensation catalyst, the composition is typically a two-part composition where the silicone resin and condensation catalyst are in separate parts.

A reinforced silicone resin film according to the present invention comprises:

a cured product of at least one silicone resin comprising disilyloxane units having the formula O_{(3-a)/2}R¹ₐSi—SiR¹_{b}O_{(3-b)/2} (I), wherein each R¹ is independently —H, hydrocarbyl, or substituted hydrocarbyl, a is 0, 1, or 2, and b is 0, 1, 2 or 3; and

a carbon nanomaterial dispersed in the cured product.

The reinforced silicone resin film comprises a cured product of at least one silicone resin comprising disilyloxane units having the formula (I), where the silicone resin is as described and exemplified above. As used herein, the term “cured product of at least one silicone resin” refers to a cross-linked silicone resin having a three-dimensional network structure

The cured product of the silicone resin can be prepared as described below in the method of preparing the reinforced silicone resin film of the present invention.

The reinforced silicone resin film also comprises a carbon nanomaterial, which is as described and exemplified above. The concentration of the carbon nanomaterial in the reinforced silicone resin film is typically from 0.0001 to 99% (w/w), alternatively from 0.001 to 50% (w/w), alternatively from 0.01 to 25% (w/w), based on the weight of the film.

The reinforced silicone resin film can further comprise a fiber reinforcement embedded in the film. The fiber reinforcement can be any reinforcement comprising fibers, provided the reinforcement has a high modulus and high tensile strength. The fiber reinforcement typically has a Young's modulus at 25° C. of at least 3 GPa. For example, the reinforcement typically has a Young's modulus at 25° C. of from 3 to 1,000 GPa, alternatively from 3 to 200 GPa, alternatively from 10 to 100 GPa. Moreover, the reinforcement typically has a tensile strength at 25° C. of at least 50 MPa. For example, the reinforcement typically has a tensile strength at 25° C. of from 50 to 10,000 MPa, alternatively from 50 to 1,000 MPa, alternatively from 50 to 500 MPa.

The fiber reinforcement can be a woven fabric, e.g., a cloth; a nonwoven fabric, e.g., a mat or roving; or loose (individual) fibers. The fibers in the reinforcement are typically cylindrical in shape and have a diameter of from 1 to 100 μm, alternatively from 1 to 20 μm, alternatively form 1 to 10 μm. Loose fibers may be continuous, meaning the fibers extend throughout the reinforced silicone resin film in a generally unbroken manner, or chopped.

The fiber reinforcement is typically heat-treated prior to use to remove organic contaminants. For example, the fiber reinforcement is typically heated in air at an elevated temperature, for example, 575° C., for a suitable period of time, for example 2 h.

Examples of fiber reinforcements include, but are not limited to reinforcements comprising glass fibers; quartz fibers; graphite fibers; nylon fibers; polyester fibers; aramid fibers, such as Kevlar® and Nomex®; polyethylene fibers; polypropylene fibers; and silicon carbide fibers.

The concentration of the fiber reinforcement in the reinforced silicone resin film is typically from 0.1 to 95% (w/w), alternatively from 5 to 75% (w/w), alternatively from 10 to 40% (w/w), based on the total weight of the film.

The reinforced silicone resin film can be prepared by a method comprising:

coating a release liner with a nanomaterial-filled silicone composition, wherein the silicone composition comprises (A) a silicone resin comprising disilyloxane units having the formula O_{(3-a)/2}R¹ₐSi—SiR¹_{b}O_{(3-b)/2} (I), wherein each R¹ is independently —H, hydrocarbyl, or substituted hydrocarbyl, a is 0, 1, or 2, and b is 0, 1, 2 or 3, (B) a carbon nanomaterial, and (C) an organic solvent; and

curing the silicone resin of the coated release liner.

In the immediately preceding method of preparing the reinforced silicone resin film, a release liner is coated with a nanomaterial-filled silicone composition, where the nanomaterial-filled silicone composition is as described and exemplified above.

The release liner can be any rigid or flexible material having a surface from which the silicone resin film can be removed without damage by delamination after the silicone resin is cured, as described below. Examples of release liners include, but are not limited to, silicon, quartz; fused quartz; aluminum oxide; ceramics; glass; metal foils; polyolefins such as polyethylene, polypropylene, polystyrene, and polyethyleneterephthalate; fluorocarbon polymers such as polytetrafluoroethylene and polyvinylfluoride; polyamides such as Nylon; polyimides; polyesters such as poly(methyl methacrylate); epoxy resins; polyethers; polycarbonates; polysulfones; and polyether sulfones. The release liner can also be a material, as exemplified above, having a surface treated with a release agent, such as a silicone release agent.

The release liner can be coated with the nanomaterial-filled silicone composition using conventional coating techniques, such as spin coating, dipping, spraying, brushing, or screen-printing. The amount of silicone composition is sufficient to form a cured silicone resin film having a thickness of from 0.01 to 1000 μm in the curing step of the method, described below.

The method of preparing the reinforced silicone resin film can further comprise, after the step of coating and before the step of curing, described below, applying a second release liner to the coated release liner to form an assembly, where the second release liner is in contact with the coating, and compressing the assembly. The assembly can be compressed to remove excess silicone composition and/or entrapped air, and to reduce the thickness of the coating. The assembly can be compressed using conventional equipment such as a stainless steel roller, hydraulic press, rubber roller, or laminating roll set. The assembly is typically compressed at a pressure of from 1,000 Pa to 10 MPa and at a temperature of from room temperature (˜23±2° C.) to 50° C.

The silicone resin of the coated release liner is cured. The silicone resin can be cured by heating the coating at a temperature sufficient to cure the silicone resin. For example, the silicone resin can be cured by heating the coating at a temperature of from 50 to 250° C., for a period of from 1 to 50 h. When the nanomaterial-filled silicone composition used to coat the release liner comprises a condensation catalyst, the silicone resin can typically be cured at a lower temperature, e.g., from room temperature (˜23±2° C.) to 200° C.

The silicone resin can be cured at atmospheric or subatmospheric pressure, depending on the method, described above, employed to coat the release liner with the nanomaterial-filled silicone composition. For example, when the coating is not enclosed between two release liners, the silicone resin is typically cured at atmospheric pressure in air. Alternatively, when the coating is enclosed between a first and second release liner, the silicone resin is typically cured under reduced pressure. For example, the silicone resin can be heated under a pressure of from 1,000 to 20,000 Pa, alternatively from 1,000 to 5,000 Pa. The silicone resin can be cured under reduced pressure using a conventional vacuum bagging process. In a typically process, a bleeder (e.g., polyester) is applied over the coated release liner, a breather (e.g, Nylon, polyester) is applied over the bleeder, a vacuum bagging film (e.g., Nylon) equipped with a vacuum nozzle is applied over the breather, the assembly is sealed with tape, a vacuum (e.g., 1,000 Pa) is applied to the sealed assembly and, if necessary, the evacuated assembly is heated as described above.

The preceding method of preparing the reinforced silicone resin film can further comprise repeating coating and curing steps to increase the thickness of the film, provided the same nanomaterial-filled silicone composition is used for each coating step.

The method of preparing the reinforced silicone resin film can further comprise the step of separating the cured silicone resin from the release liner(s). The cured silicone resin can be separated from the release liner by mechanically peeling the film away from the release liner.

When the reinforced silicone resin film further comprises a fiber reinforcement embedded in the film, the reinforced silicone resin film can be prepared by a method comprising:

impregnating a fiber reinforcement in a nanomaterial-filled silicone composition, wherein the silicone composition comprises (A) a silicone resin comprising disilyloxane units having the formula O_{(3-a)/2}R¹ₐSi—SiR¹_{b}O_{(3-b)/2} (I), wherein each R¹ is independently —H, hydrocarbyl, or substituted hydrocarbyl, a is 0, 1, or 2, and b is 0, 1, 2 or 3, (B) a carbon nanomaterial, and (C) an organic solvent; and

curing the silicone resin of the impregnated fiber reinforcement.

A fiber reinforcement is impregnated in a nanomaterial-filled silicone composition, wherein the nanomaterial-filled silicone composition is as described and exemplified above.

The fiber reinforcement can be impregnated in the nanomaterial-filled silicone composition using a variety of methods. For example, according to a first method, the fiber reinforcement can be impregnated by (i) applying a nanomaterial-filled silicone composition to a release liner to form a film; (ii) embedding a fiber reinforcement in the film; and (iii) applying the nanomaterial-filled silicone composition to the embedded fiber reinforcement to form an impregnated fiber reinforcement.

In step (i) of the immediately preceding method of impregnating a fiber reinforcement, a nanomaterial-filled silicone composition is applied to a release liner to form a film. The release liner and the nanomaterial-filled silicone composition are as described and exemplified above. The composition can be applied to the release liner using conventional coating techniques, such as spin coating, dipping, spraying, brushing, extrusion, or screen-printing. The composition is applied in an amount sufficient to embed the fiber reinforcement in step (ii), below.

In step (ii), a fiber reinforcement is embedded in the film. The fiber reinforcement is as described and exemplified above. The fiber reinforcement can be embedded in the film by simply placing the reinforcement on the film and allowing the composition of the film to saturate the reinforcement.

In step (iii) the nanomaterial-filled silicone composition is applied to the embedded fiber reinforcement to form an impregnated fiber reinforcement. The composition can be applied to the embedded fiber reinforcement using conventional methods, as described above for step (i).

The first method of impregnating a fiber reinforcement can further comprise the steps of (iv) applying a second release liner to the impregnated fiber reinforcement to form an assembly; and (v) compressing the assembly. Also, the first method can further comprise after step (ii) and before step (iii), degassing the embedded fiber reinforcement and/or after step (iii) and before step (iv), degassing the impregnated fiber reinforcement.

The assembly can be compressed to remove excess silicone composition and/or entrapped air, and to reduce the thickness of the impregnated fiber reinforcement. The assembly can be compressed using conventional equipment such as a stainless steel roller, hydraulic press, rubber roller, or laminating roll set. The assembly is typically compressed at a pressure of from 1,000 Pa to 10 MPa and at a temperature of from room temperature to 200° C.

The embedded or impregnated fiber reinforcement can be degassed by subjecting it to a vacuum at a temperature of from room temperature (˜23±2° C.) to 60° C., for a period of time sufficient to remove entrapped air in the embedded or impregnated reinforcement. For example, the embedded or impregnated fiber reinforcement can typically be degassed by subjecting it to a pressure of from 1,000 to 20,000 Pa for 5 to 60 min. at room temperature.

Alternatively, according to a second method, the fiber reinforcement can be impregnated in the nanomaterial-filled silicone composition by (i) depositing a fiber reinforcement on a release liner; (ii) embedding the fiber reinforcement in a nanomaterial-filled silicone composition; and (iii) applying the nanomaterial-filled silicone composition to the embedded fiber reinforcement to form an impregnated fiber reinforcement. The second method can further comprise the steps of (iv) applying a second release liner to the impregnated fiber reinforcement to form an assembly; and (v) compressing the assembly. In the second method, steps (iii) to (v) are as described above for the first method of impregnating a fiber reinforcement in the nanomaterial-filled silicone. Also, the second method can further comprise after step (ii) and before step (iii), degassing the embedded fiber reinforcement and/or after step (iii) and before step (iv), degassing the impregnated fiber reinforcement.

In step (ii) of the immediately preceding method of impregnating a fiber reinforcement, a fiber reinforcement is embedded in a nanomaterial-filled silicone composition. The fiber reinforcement can be embedded in the silicone composition by simply covering the reinforcement with the composition and allowing the composition to saturate the reinforcement.

Furthermore, when the fiber reinforcement is a woven or nonwoven fabric, the reinforcement can be impregnated in a nanomaterial-filled silicone composition by passing it through the composition. The fabric is typically passed through the silicone composition at a rate of from 1 to 1,000 cm/min.

The silicone resin of the impregnated fiber reinforcement is cured. The silicone resin can be cured by heating the impregnated fiber reinforcement at a temperature sufficient to cure the silicone resin. For example, the silicone resin can typically be cured by heating the impregnated fiber reinforcement at a temperature of from 50 to 250° C., for a period of from 1 to 50 h. When the nanomaterial-filled silicone composition used to impregnate the fiber reinforcement comprises a condensation catalyst, the silicone resin can typically be cured at a lower temperature, e.g., from room temperature (˜23±2° C.) to 200° C.

The silicone resin of the impregnated fiber reinforcement can be cured at atmospheric or subatmospheric pressure, depending on the method, described above employed to impregnate the fiber reinforcement in the nanomaterial-filled silicone composition. For example, when the coating is not enclosed between two release liners, the silicone resin is typically cured at atmospheric pressure in air. Alternatively, when the coating is enclosed between a first and second release liner, the silicone resin is typically cured under reduced pressure. For example, the silicone resin can be heated under a pressure of from 1,000 to 20,000 Pa, alternatively from 1,000 to 5,000 Pa. The silicone resin can be cured under reduced pressure using a conventional vacuum bagging process. In a typically process, a bleeder (e.g., polyester) is applied over the coated release liner, a breather (e.g, Nylon, polyester) is applied over the bleeder, a vacuum bagging film (e.g., Nylon) equipped with a vacuum nozzle is applied over the breather, the assembly is sealed with tape, a vacuum (e.g., 1,000 Pa) is applied to the sealed assembly and, if necessary, the evacuated assembly is heated as described above.

The method of preparing the reinforced silicone resin film comprising a fiber reinforcement can further comprise repeating the impregnating and curing steps to increase the thickness of the film, provided the same nanomaterial-filled silicone composition is used for each impregnation.

When the reinforced silicone resin film comprising a fiber reinforcement is formed on a release liner, the method of preparing the reinforced silicone resin film further comprises separating the film from the release liner. The reinforced silicone resin film can be separated from the release liner by mechanically peeling the film away from the release liner.

The reinforced silicone resin film of the present invention typically comprises from 10 to 99% (w/w), alternatively from 30 to 95% (w/w), alternatively from 60 to 95% (w/w), alternatively from 80 to 95% (w/w), of the cured silicone resin. Also, the reinforced silicone resin film typically has a thickness of from 0.01 to 1000 μm, alternatively from 5 to 500 μm, alternatively from 10 to 100 μm.

The silicone resin film typically has a flexibility such that the film can be bent over a cylindrical steel mandrel having a diameter less than or equal to 3.2 mm without cracking, where the flexibility is determined as described in ASTM Standard D522-93a, Method B.

The silicone resin film has low coefficient of linear thermal expansion (CTE), high tensile strength, and high modulus. For example the film typically has a CTE of from 0 to 80 μm/m° C., alternatively from 0 to 20 μm/m° C., alternatively from 2 to 10 μm/m° C., at temperature of from room temperature (˜23±2° C.) to 200° C. Also, the film typically has a tensile strength at 25° C. of from 5 to 200 MPa, alternatively from 20 to 200 MPa, alternatively from 50 to 200 MPa. Further, the silicone resin film typically has a Young's modulus at 25° C. of from 0.3 to 10 GPa, alternatively from 1 to 6 GPa, alternatively from 3 to 5 GPa.

The transparency of the silicone resin film depends on a number of factors, such as the composition of the cured silicone resin, the thickness of the film, and the type and concentration of the carbon nanomaterial. The silicone resin film typically has a transparency (% transmittance) of at least 50%, alternatively at least 60%, alternatively at least 75%, alternatively at least 85%, in the visible region of the electromagnetic spectrum.

The reinforced silicone resin film of the present invention has low coefficient of thermal expansion, high tensile strength, and high modulus compared to an un-reinforced silicone resin film prepared from the same silicone composition. Also, although the reinforced and un-reinforced silicone resin films have comparable glass transition temperatures, the reinforced film exhibits a much smaller change in modulus in the temperature range corresponding to the glass transition.

The reinforced silicone resin film of the present invention is useful in applications requiring films having high thermal stability, flexibility, mechanical strength, and transparency. For example, the silicone resin film can be used as an integral component of flexible displays, solar cells, flexible electronic boards, touch screens, fire-resistant wallpaper, and impact-resistant windows. The film is also a suitable substrate for transparent or nontransparent electrodes.

### Examples

The following examples are presented to better illustrate the nanomaterial-filled silicone composition and reinforced silicone resin film of the present invention, but are not to be considered as limiting the invention, which is delineated in the appended claims. Unless otherwise noted, all parts and percentages reported in the examples are by weight. The following methods and materials were employed in the examples:

### Measurement of Mechanical Properties

Young's modulus, tensile strength, and tensile strain at break were measured using an MTS Alliance RT/5 testing frame, equipped with a 100-N load cell. Young's modulus, tensile strength, and tensile strain were determined at room temperature (˜23±2° C.) for the test specimens of Examples 4 and 7.

The test specimen was loaded into two pneumatic grips spaced apart 25 mm and pulled at a crosshead speed of 1 mm/min. Load and displacement data were continuously collected. The steepest slope in the initial section of the load-displacement curve was taken as the Young's modulus. Reported values for Young's modulus (GPa), tensile strength (MPa), and tensile strain (%) each represent the average of three measurements made on different dumbbell-shaped test specimens from the same silicone resin film.

The highest point on the load-displacement curve was used to calculate the tensile strength according to the equation:

σ=F/(wb),

where:
σ=tensile strength, MPa,
F=highest force, N,
w=width of the test specimen, mm, and
b=thickness of the test specimen, mm.

The tensile strain at break was approximated by dividing the difference in grip separation before and after testing by the initial separation according to the equation:

σ=100(l₂−l₁)/l₁,

where:
ε=tensile strain at break, %,
l₂=final separation of the grips, mm, and
l₁=initial separation of the grips, mm.

Pyrograf®-III grade HHT-19 carbon nanofiber, sold by Pyrograf Products, Inc. (Cedarville, Ohio), is a heat-treated (up to 3000° C.) carbon nanofiber having a diameter of 100 to 200 nm and a length of 30,000 to 100,000 nm.

Disilane Composition A is a chlorodisilane stream obtained by fractional distillation of the residue produced in the direct process for manufacturing methylchlorosilanes. The composition contains Me₄Cl₂Si₂, 1.63%; Me₃Cl₃Si₂, 33.7%, and Me₂Cl₄Si₂, 63.75%, based on total weight.

Glass Fabric is a heat-treated glass fabric prepared by heating style 106 electrical glass fabric having a plain weave and a thickness of 37.5 μm at 575° C. for 6 h. The untreated glass fabric was obtained from JPS Glass (Slater, S.C.).

### Example 1

This example demonstrates the preparation of a chemically oxidized carbon nanofiber. Pyrograf®-III carbon nanofiber (2.0 g), 12.5 mL of concentrated nitric acid, and 37.5 mL of concentrated sulfuric acid were combined sequentially in a 500-mL three-neck flask equipped with a condenser, a thermometer, a Teflon-coated magnetic stirring bar, and a temperature controller. The mixture was heated to 80° C. and kept at this temperature for 3 h. The mixture was then cooled by placing the flask on a layer of dry ice in a one gallon pail. The mixture was poured into a Buchner funnel containing a nylon membrane (0.8 μm) and the carbon nanofibers were collected by vacuum filtration. The nanofibers remaining on the membrane were washed several times with deionized water until the pH of the filtrate was equal to the pH of the wash water. After the last wash, the carbon nanofibers were kept in the funnel for an additional 15 min. with continued application of the vacuum. Then the nanofibers, supported on the filter membrane, were placed in an oven at 100° C. for 1 h. The carbon nanofibers were removed from filter membrane and stored in a dry sealed glass jar.

### Example 2

Disilane Composition A (15 g) was mixed with 28.6 g PhSiCl₃, 120 g of methyl isobutyl ketone, and 19.48 g of anhydrous methanol. The HCl produced from the reaction was allowed to escape from the open mouth of the flask. The liquid mixture was placed in a sealed bottle, chilled in an ice water bath, and then transferred to an addition funnel mounted on top of a three necked round bottom flask equipped with a stirrer and a thermometer. Deionized water (120 g) was placed in the flask and cooled with an external ice water bath to 2 to 4° C. The mixture in the addition funnel was continuously added to the chilled deionized water over a period of 10 min., during which time the temperature of the mixture increased by 3 to 5° C. After completion of the addition, the mixture was stirred in the ice bath for 1 h. The flask was then heated to 50 to 75° C. with a water bath and held at that temperature for 1 h. The mixture was allowed to cool to room temperature and then washed with a solution of 10 g of NaCl in 200 mL of water, four times. After each wash the aqueous phase was discarded. The organic phase was isolated, centrifuged, and filtered. The organic phase had a silicone resin content of 21.25% (w/w).

### Example 3

The oxidized carbon nanofiber of Example 1 (0.011 g) and 26 grams of the silicone resin preparation of Example 2 were combined in a glass vial. The vial was placed in an ultrasonic bath for 30 min. The mixture was then subjected to centrifugation at 2000 rpm for 30 min. The supernatant silicone composition was used to prepare a reinforced silicone resin film, as described below.

### Example 4

Glass fabric (38.1 cm×8.9 cm) was impregnated with the silicone composition of Example 3 by passing the fabric through the composition at a rate of about 5 cm/s. The impregnated fabric was then hung vertically in a fume hood at room temperature for 2 h, and then cured in an air-circulating oven according to the following cycle: 50° C., 2 h; 50° C. to 150° C. at 2.5° C./min., 150° C. for 0.5 h. The oven was turned off and the reinforced silicone resin film was allowed to cool to room temperature. The mechanical properties of the reinforced silicone resin film are shown in Table 1.

### Example 5

Disilane Composition A (50 g), was mixed with 31 g MeSiCl₃, 300 g of methyl isobutyl ketone, and 80 ml of anhydrous methanol. The HCl produced from the reaction was allowed to escape from the open mouth of the flask. The liquid mixture was placed in a sealed bottle, chilled in an ice water bath, and then transferred to an addition funnel mounted on top of a three necked round bottom flask equipped with a stirrer and a thermometer. Deionized water (250 g) was placed in the flask and cooled with an external ice water bath to 2 to 4° C. The mixture in the addition funnel was continuously added to the chilled deionized water over a period of 10 min., during which time the temperature of the mixture increased by 3 to 5° C. After completion of the addition, the mixture was stirred in the ice bath for 1 h. The flask was then heated to 50 to 75° C. with a water bath and held at that temperature for 1 h. The mixture was allowed to cool to room temperature and then washed with a solution of 10 g of NaCl in 200 mL of water, four times. After each wash the aqueous phase was discarded. The organic phase was isolated, centrifuged, and filtered. The organic phase had a silicone resin content of 13.70% (w/w). The organic phase was then concentrated at 80° C. and a pressure of 5 mm Hg (667 Pa) to produced a solution containing 27.40% (w/w) of the silicone resin.

### Example 6

The oxidized carbon nanofiber of Example 1 (0.011 g) and 26 grams of the silicone resin preparation of Example 5 were combined in a glass vial. The vial was placed in an ultrasonic bath for 30 min. The mixture was then subjected to centrifugation at 2000 rpm for 30 min. The supernatant silicone composition was used to prepare a silicone resin film, as described below.

### Example 7

A reinforced silicone resin film was prepared according to the method of Example 4, except the silicone composition of Example 3 was replaced with the silicone composition of Example 6. The mechanical properties of the reinforced silicone resin film are shown in Table 1.

TABLE 1

| | | Tensile | Young's | |
|---|---|---|---|---|
| | Thickness | Strength | Modulus | Strain at Break |
| Example | (mm) | (MPa), Warp | (GPa), Warp | (%), Warp |
| 4 | 0.039 | 50.7 | 2.61 | 2.26 |
| 7 | 0.035 | 64.0 | 2.98 | 2.39 |

That which is claimed is:

1. A nanomaterial-filled silicone composition, comprising:
(A) a silicone resin comprising disilyloxane units having the formula O_{(3-a)/2}R¹ₐSi—SiR¹_{b}O_{(3-b)/2} (I), wherein each R¹ is independently —H, hydrocarbyl, or substituted hydrocarbyl, a is 0, 1, or 2, and b is 0, 1, 2 or 3;
(B) a carbon nanomaterial; and
(C) an organic solvent.

2. The silicone composition according to claim 1, wherein the silicone resin comprises at least 1 mol % of disilyloxane units having the formula (I).

3. The silicone composition according to claim 1, wherein the silicone resin contains in addition to disilyloxane units having the formula (I), other siloxane units.

4. The silicone composition according to claim 1, wherein the silicone resin has the formula: [O_{(3-a)/2}R¹ₐSi—SiR¹_{b}O_{(3-b)/2}]ᵥ(R¹₃SiO_{1/2})_{w}(R¹₂SiO_{2/2})ₓ(R¹SiO_{3/2})_{y}(SiO_{4/2})_{z} (II), wherein each R¹ is independently —H, hydrocarbyl, or substituted hydrocarbyl; a is 0, 1, or 2; b is 0, 1, 2 or 3; v is from 0.01 to 1; w is from 0 to 0.84; x is from 0 to 0.99; y is from 0 to 0.99; z is from 0 to 0.95; and v+w+x+y+z=1.

5. The silicone composition according to claim 1, wherein the silicone resin comprises disilyloxane units having the formula O_{(3-a/2}R¹ₐSi—SiR¹_{b}O_{(3-b)/2} (I), and siloxane units having the form of particles, wherein each R¹ is independently —H, hydrocarbyl, or substituted hydrocarbyl; a is 0, 1, or 2; and b is 0, 1, 2 or 3.

6. The silicone composition according to claim 5, wherein the silicone resin comprises from 10 to 70 mol % of disilyloxane units having the formula (I).

7. The silicone composition according to claim 5, wherein the silicone resin comprises in addition to disilyloxane units having the formula (I) and siloxane units having the form of particles, other siloxane units.

8. The silicone composition according to claim 5, wherein the silicone resin comprises from 1 to 80 mol % of silxoane units having the form of particles.

9. The silicone composition according to claim 5, wherein the particles have a median size of from 0.001 to 500 μm.

10. The silicone composition according to claim 5, wherein the particles are selected from silica particles, silicone resin particles, silicone elastomer particles, and metal polysilicate particles.

11. The silicone composition according to claim 1, further comprising at least one of a cross-linking agent and a condensation catalyst.

12. The silicone composition according to claim 1, wherein the carbon nanomaterial is selected from at least one of carbon nanoparticles, fibrous carbon nanomaterials, and layered carbon nanomaterials.

13. The silicone composition according to claim 1, wherein the carbon nanomaterial comprises carbon nanofibers.

14. The silicone composition according to claim 1, wherein the carbon nanomaterial is an oxidized carbon nanomaterial.

15. The silicone composition according to claim 1, wherein the concentration of component (B) is from 0.001 to 50% (w/w).

16. A reinforced silicone resin film, comprising:
a cured product of at least one silicone resin comprising disilyloxane units having the formula O_{(3-a)/2}R¹ₐSi—SiR¹_{b}O_{(3-b)/2} (I), wherein each R¹ is independently —H, hydrocarbyl, or substituted hydrocarbyl, a is 0, 1, or 2, and b is 0, 1, 2 or 3; and
a carbon nanomaterial dispersed in the cured product.

17. The reinforced silicone resin film according to claim 16, wherein the silicone resin has the formula: [O_{(3-a)/2}R¹ₐSi—SiR¹_{b}O_{(3-b)/2}]ᵥ(R¹₃SiO_{1/2})_{w}(R¹₂SiO_{2/2})ₓ(R¹SiO_{3/2})_{y}(SiO_{4/2})_{z} (II), wherein each R¹ is independently —H, hydrocarbyl, or substituted hydrocarbyl; a is 0, 1, or 2; b is 0, 1, 2 or 3; v is from 0.01 to 1; w is from 0 to 0.84; x is from 0 to 0.99; y is from 0 to 0.99; z is from 0 to 0.95; and v+w+x+y+z=1.

18. The reinforced silicone resin film according to claim 16, wherein the silicone resin comprises disilyloxane units having the formula O_{(3-a)/2}R¹ₐSi—SiR¹_{b}O_{(3-b)/2} (I), and siloxane units having the form of particles, wherein each R¹ is independently —H, hydrocarbyl, or substituted hydrocarbyl; a is 0, 1, or 2; and b is 0, 1, 2 or 3.

19. The reinforced silicone resin film according to claim 16, wherein the carbon nanomaterial is selected from at least one of carbon nanoparticles, fibrous carbon nanomaterials, and layered carbon nanomaterials.

20. The reinforced silicone resin film according to claim 16, wherein the carbon nanomaterial is a carbon nanofiber.

21. The reinforced silicone resin film according to claim 16, wherein the concentration of the carbon nanomaterial is from 0.001 to 50% (w/w).

22. The reinforced silicone resin film according to claim 16, further comprising a fiber reinforcement embedded in the film.

23. The reinforced silicone resin film according to claim 22, wherein the fiber reinforcement comprises glass fibers.

24. The reinforced silicone resin film according to claim 16, wherein the film has a thickness of from 5 to 500 μm.
